(19) United States
(12) Patent Application Publication
(10) Pub. No.: US 2026/0273650 A1
(43) Pub. Date: Sep. 17, 2026

(54) SPOT WELDING GUN

(71) Applicant: SUBARU CORPORATION, Tokyo (JP)

(72) Inventor: Masahiro YOKOI, Tokyo (JP)

(21) Appl. No.: 19/547,871

(22) Filed: Feb. 24, 2026

(30) Foreign Application Priority Data
Mar. 17, 2025 (JP) 2025-042410

(51) Int. Cl. B23K 11/31; B23K 11/11

(52) U.S. Cl. CPC B23K 11/314; B23K 11/11

(57) ABSTRACT

A spot welding gun comprises an electrode and a pressing mechanism. The electrode contacts a workpiece. The pressing mechanism applies a pressing force to the workpiece by pressing the electrode. The pressing mechanism comprises a pressing rod, at least one link member, and a spring member. The pressing rod has a distal end to which the electrode is coupled and reciprocates in its axial direction. The link member includes a distal and proximal end portions. The distal end portion is coupled to a proximal end side of the pressing rod via a joint member and extends in a direction inclined with respect to the pressing rod so that the proximal end portion becomes more distant from the electrode. The spring member urges the link member toward the distal end portion. An inclination angle of the link member decreases as the pressing rod moves toward the electrode.

### CROSS-REFERENCE TO RELATED APPLICATIONS

The present application claims priority from Japanese Patent Application No. 2025-042410 filed on Mar. 17, 2025, the entire contents of which are hereby incorporated by reference.

### BACKGROUND

The disclosure relates to a spot welding gun used for spot welding. In particular, the disclosure relates to a spot welding gun including a pressing mechanism that presses an electrode against a workpiece, which is to be welded, in a state in which the electrode is in contact with the workpiece.

As a method of welding a metal panel, resistance welding is known. Resistance welding is a method of welding panels to each other by using resistance heat that is generated between the panels by causing an electric current to flow through a workpiece, in which the panels overlap each other, while pressing the workpiece. In spot welding, which is a type of resistance welding, flow of an electric current between panels in a weld zone is ensured by causing the electric current to flow between two electrodes in a state in which the electrodes are in pressed contact with a workpiece.

Spot welding is widely used in production lines for mass production of products. For example, in a production line for mass production of vehicle bodies, spot welding is used to weld panels of a vehicle body. A spot welding apparatus for performing spot welding includes a spot welding gun, including an electrode, attached to a distal end portion of a robot arm. The spot welding gun moves to a predetermined welding position as the robot arm operates. When a distal end portion of an electrode used for spot welding wears due to multiple spot welding or when plating on a workpiece surface adheres to a surface of the electrode during welding, welding quality declines. Therefore, the surface of the end portion of the electrode is periodically polished to maintain the surface condition.

A spot welding gun includes a pressing mechanism that applies a pressing force to a workpiece by pressing an electrode in a state in which the electrode is in contact with the workpiece. For example, Japanese Unexamined Patent Application Publication (JP-A) No. 2008-290149 describes a spot welding gun including, as the pressing mechanism, an air cylinder that presses an electrode against a workpiece. When the electrode is polished to maintain welding quality, the distance from a robot arm to a distal end of the electrode decreases, and a stroke length, over which a piston rod of the air cylinder moves, increases. With the spot welding gun of JP-A No. 2008-290149, by controlling the air pressure of the air cylinder, it is possible to perform control so that a pressing force applied to a workpiece remains substantially constant even when the stroke length of the piston rod changes.

### SUMMARY

An aspect of the disclosure provides a spot welding gun comprising an electrode and a pressing mechanism. The electrode is configured to contact a workpiece to be welded. The pressing mechanism is configured to apply a pressing force to the workpiece by pressing the electrode. The pressing mechanism comprises a pressing rod, at least one link member, and a spring member. The pressing rod has a distal end to which the electrode is coupled and is configured to reciprocate in an axial direction of the pressing rod. The at least one link member includes a distal end portion and a proximal end portion. The distal end portion is coupled to a proximal end side of the pressing rod via a joint member and extends in a direction inclined with respect to the pressing rod so that the proximal end portion becomes more distant from the electrode. The spring member is configured to urge the link member toward the distal end portion. An inclination angle of the link member with respect to the pressing rod decreases as the pressing rod moves toward the electrode.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a perspective view of a spot welding gun according to an embodiment of the disclosure;

FIG. 2 is a schematic explanatory view of a spot welding apparatus including the spot welding gun;

FIG. 3 is an explanatory view of indirect spot welding performed by the spot welding apparatus;

FIG. 4 is a perspective view illustrating main portions of the spot welding gun;

FIG. 5 is a side view illustrating the main portions of the spot welding gun;

FIG. 6 is a sectional view illustrating the main portions of the spot welding gun;

FIG. 7A is a view illustrating an operation of a pressing mechanism of the spot welding gun;

FIG. 7B is a view illustrating an operation of the pressing mechanism of the spot welding gun; and

FIG. 8 is a graph illustrating the relationship between stroke length and thrust generated in a pressing rod.

### DETAILED DESCRIPTION

In recent years, from the viewpoint of carbon neutrality, it is desired to reduce energy consumption in the production process of a product, that is, to reduce energy consumption when a spot welding apparatus operates.

In existing spot welding guns, an air cylinder used in a pressing mechanism, which moves a piston by supplying and discharging air for each welding spot, has a problem in that the amount of consumption of compressed air made by an electric compressor is large and the energy efficiency is low.

It is desirable to provide a spot welding gun that can apply a substantially constant pressing force to a workpiece by pressing an electrode during welding and can reduce energy consumption.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

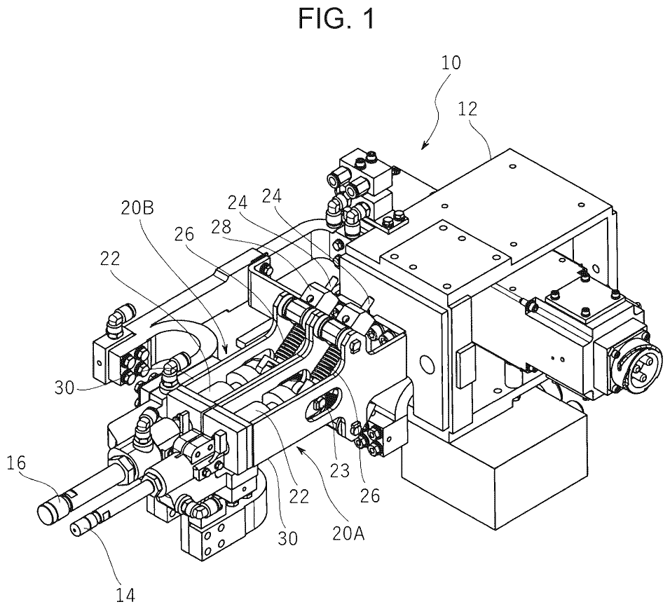

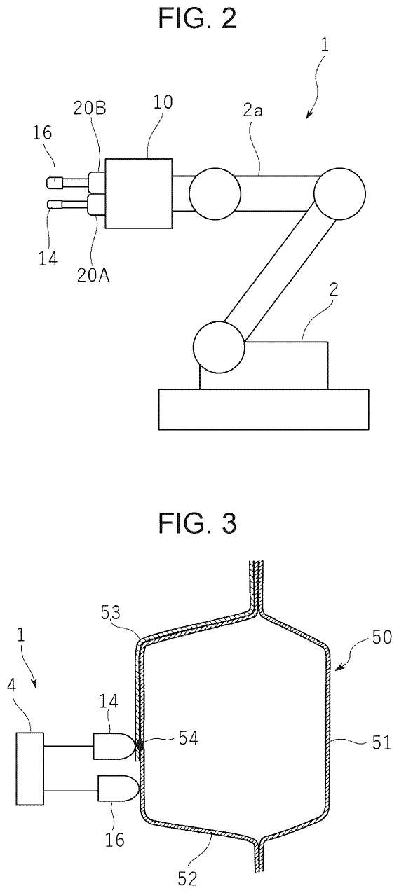

FIG. 1 is a perspective view of a spot welding gun 10 according to the embodiment of the disclosure. FIG. 2 is a schematic explanatory view of a spot welding apparatus 1 including the spot welding gun 10. The spot welding apparatus 1 is used, for example, in a step of welding panels of a vehicle body in a production line for mass production of vehicles such as automobiles. The spot welding apparatus 1 is used to weld metal panels at least parts of which overlap each other. As illustrated in FIG. 2, the spot welding gun 10 is attached to a distal end portion of a robot arm 2a of an industrial robot 2, and includes a first electrode 14 and a second electrode 16.

The spot welding gun 10 according to the present embodiment is a welding gun for performing indirect spot welding. As illustrated in FIG. 3, the spot welding apparatus 1 including the spot welding gun 10 is used, for example, to weld a stacked region of a workpiece 50 including a first panel 51, a second panel 52, and a third panel 53. The stacked region is a region where the second panel 52 and the third panel 53 are stacked and where direct spot welding cannot be performed. The first electrode 14 of the spot welding gun 10 is a welding electrode that contacts the surface of a weld zone of the workpiece 50, and the second electrode 16 is a ground electrode that contacts the surface of a portion different from the weld zone. As the distal end portion of the robot arm 2a moves, the spot welding gun 10 is disposed at a predetermined welding position where welding is to be performed on the workpiece 50.

The spot welding apparatus 1 welds the overlapping panels 52 and 53 to each other by causing an electric current to flow between the two electrodes 14 and 16 in a state in which the electrodes 14 and 16 are in pressed contact with the workpiece 50 based on a welding condition that is preset by a control device 4. Thus, a nugget 54 is formed around the boundary plane between the second panel 52 and the third panel 53 in a portion in contact with the first electrode 14, which is a welding electrode. The control device 4 includes, for example, an information processor such as a CPU, a storage such as a RAM or a ROM, an input/output interface, and the like. Based on a program stored in the storage, the control device 4 controls the value of an electric current supplied from a welding transformer (not illustrated) to the first electrode 14.

As illustrated in FIG. 1, the spot welding gun 10 includes a gun body 12, the first electrode 14, the second electrode 16, a first pressing mechanism 20A provided on the first electrode 14, and a second pressing mechanism 20B provided on the second electrode 16. As illustrated in FIG. 2, the gun body 12 is fixed to the distal end portion of the robot arm 2a by using a fastener such as a bolt. The first electrode 14 and the second electrode 16 are attached to the gun body 12 via the first pressing mechanism 20A and the second pressing mechanism 20B, respectively.

The first pressing mechanism 20A and the second pressing mechanism 20B press the first electrode 14 and the second electrode 16, respectively, to apply pressing forces to the workpiece 50 during welding. Because the first pressing mechanism 20A and the second pressing mechanism 20B have similar structures, the first pressing mechanism 20A will be described in detail in the following description.

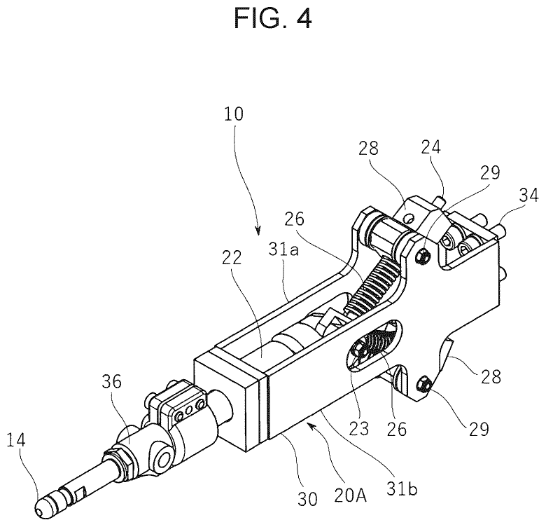

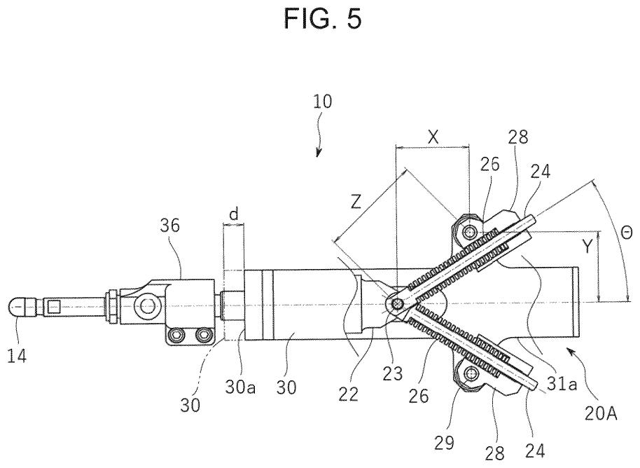

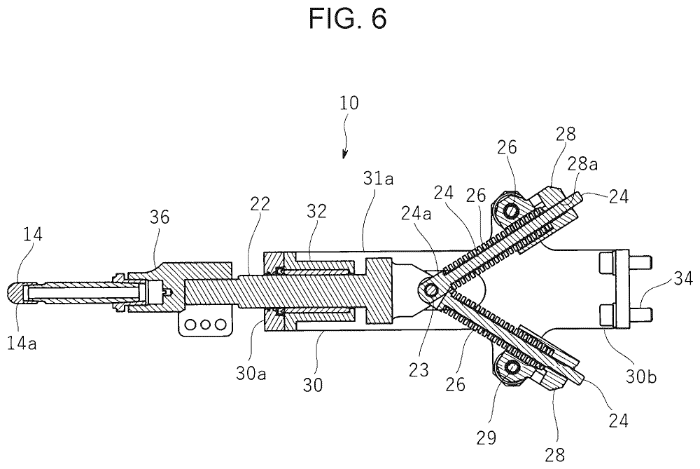

FIG. 4 is a perspective view illustrating the first pressing mechanism 20A and the first electrode 14, which are main portions of the spot welding gun 10 according to the present embodiment. FIG. 5 and FIG. 6 are a side view and a sectional view illustrating the main portions of the spot welding gun 10. The first pressing mechanism 20A (hereafter, also referred to “the pressing mechanism 20A”) includes a pressing rod 22, a holding member 30 that holds the pressing rod 22, a link member 24 that is coupled to the pressing rod 22, and a support member 28 that supports the link member 24.

The pressing rod 22 is a linearly extending member, and the first electrode 14 (hereafter, simply referred to as “the electrode 14”) is coupled to the distal end of the pressing rod 22 via a coupler 36. The pressing rod 22 is held by the holding member 30 so that the pressing rod 22 can reciprocate in the axial direction. As illustrated in FIG. 1 and FIG. 4, the holding member 30 has a substantially rectangular-parallelepiped shape. One end portion 30b of the holding member 30 in the longitudinal direction is fixed to the gun body 12 of the spot welding gun 10 by using a fastener 34 such as a bolt. The other end portion 30a of the holding member 30 in the longitudinal direction has a through hole through which a distal end portion of the pressing rod 22 extends so that the distal end portion can reciprocate.

As illustrated in FIG. 4 and FIG. 5, the holding member 30 according to the present embodiment includes two elongated plate members 31a and 31b that face each other with a distance therebetween and quadrangular end plate members that couple both end portions of the two plate members in the longitudinal direction. As illustrated in FIG. 6, the holding member 30 is provided with a guide 32 that restricts the movement direction of the pressing rod 22 so that the pressing rod 22 moves in the axial direction.

The link member 24 is a linearly-extending bar-shaped member, and a distal end portion of the link member 24 is coupled to a proximal end portion of the pressing rod 22, that is, an end portion of the pressing rod 22 away from the electrode 14, via a joint member 23. In a state of being set, the link member 24 extends in a direction inclined with respect to the pressing rod 22 so that a proximal end portion of the link member 24 becomes more distant from the electrode 14.

The proximal end portion of the link member 24 is supported by the support member 28 attached to the holding member 30. The support member 28 is rotatably attached to the holding member 30 via a shaft member 29 that extends through the plate members 31a and 31b of the holding member 30. The proximal end portion of the link member 24 extends through a through hole in the support member 28, and thus the support member 28 supports the proximal end portion of the link member 24 so that the proximal end portion can slide in the axial direction of the link member 24.

A spring member 26 is attached so as to urge the link member 24 toward the distal end portion of the link member 24. In the present embodiment, the spring member 26 is a coil spring that is attached to the outer periphery of the link member 24. One end portion of the coil spring is engaged with an engagement surface that is at the distal end portion of the link member 24 and that has a larger diameter than the coil spring. The other end portion of the coil spring is engaged by the support member 28 with the inside of a through hole through which the link member 24 extends. The coil spring is an example of the spring member 26, and a spring of another type can be used. It is sufficient that the spring member 26 be set so as to urge the link member 24 toward the distal end portion. For example, the spring member 26 may be structured to couple one end portion of the spring member 26 to the proximal end portion of the link member 24 and to urge the proximal end portion toward the distal end portion of the link member 24.

As illustrated in FIG. 4 and FIG. 5, in the spot welding gun 10, the link member 24 includes a pair of link members 24, the spring member 26 includes a pair of spring members 26, and the support member 28 includes a pair of support members 28, and the pair of link members 24, the pair of spring members 26, and the pair of support members 28 are disposed so as to be line-symmetric with respect to the axial direction of the pressing rod 22. In the pressing mechanism 20A, it is sufficient at least one link member 24, at least one spring member 26, and at least one support member 28 be provided. Three or more link members 24, three or more spring members 26, and three or more support members 28 may be provided. When multiple link members 24 and multiple spring members 26 that urge the link members 24 are provided, the link members 26 and the spring members 26 may be disposed so that a force that the spring members 26 apply to the pressing rod 22 is oriented only in the axial direction of the pressing rod 22, that is, so that forces in directions perpendicular to the axial direction cancel out.

As illustrated in FIG. 5, in the pressing mechanism 20A, the pressing rod 22, the joint member 23, and the pair of link members 24 constitute a link mechanism. As the pressing rod 22 moves in the axial direction, the inclination angle θ of each link member 24 with respect to the axial direction of the pressing rod 22 changes. For example, each link member 24 is configured so that the inclination angle θ decreases as the pressing rod 22 moves toward the electrode 14 with respect to the holding member 30. The pressing mechanism 20A can smoothly change the inclination angle of the link member 24, because the support member 28 rotates while supporting the proximal end portion of the link member 24 when the pressing rod 22 moves in the axial direction.

As illustrated in FIG. 1, the second pressing mechanism 20B provided on the second electrode 16 includes, as with the first pressing mechanism 20A, a pressing rod 22, a holding member 30 that holds the pressing rod 22, a pair of link members 24 that are coupled to the pressing rod 22, and a pair of support members 28 that support the link members 24. In the spot welding gun 10 according to the present embodiment, the pressing rod 22 of the first pressing mechanism 20A and the pressing rod 22 of the second pressing mechanism 20B are disposed parallel to each other.

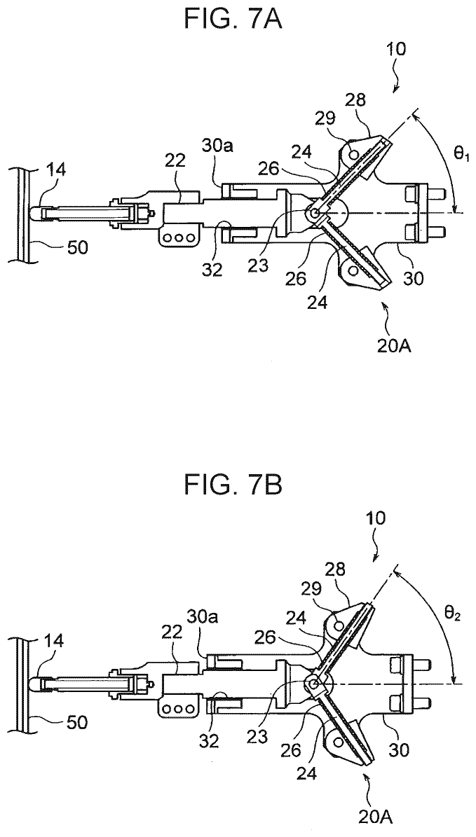

Next, referring to FIG. 5, FIG. 7A, and FIG. 7B, the operation of the pressing mechanism 20A when spot welding is performed by using the spot welding gun 10 will be described. In FIG. 5, the symbol Z denotes the distance between the joint member 23 and the support member 28, the symbol X denotes the distance between the joint member 23 and the support member 28 in the axial direction of the pressing rod 22, and the symbol Y denotes the distance between the joint member 23 and the support member 28 in a direction perpendicular to the axial direction of the pressing rod 22. The symbol d denotes a stroke length over which the pressing rod 22 can move in the axial direction. As illustrated in FIG. 7A, when the pressing rod 22 is pushed by the robot arm 2a further toward the workpiece 50 in a state in which the electrode 14 is in contact with the workpiece 50, as illustrated in FIG. 7B, the pressing rod 22 moves toward the proximal end with respect to the holding member 30, that is, the pressing rod 22 moves closer to the gun body 12 illustrated in FIG. 1. When the pressing rod 22 moves in this way, the distance Z and the distance X decrease, and the inclination angle θ increases (inclination angle θ₁<inclination angle θ₂). The distance Y remains constant.

With the spot welding apparatus 1 including the spot welding gun 10, the spot welding gun 10 is disposed by the industrial robot 2 at a predetermined welding position with respect to the workpiece 50. At the welding position, the electrode 14 is in contact with the workpiece 50, and the electrode 14 and the pressing rod 22 are in a state of being moved toward the proximal end of the pressing rod 22. This movement distance is the stroke length d, which represents the movement distance of the electrode 14 at one spot. When the spring member 26 contracts due to the movement of the pressing rod 22 toward the proximal end, the link member 24, and the pressing rod 22 and the electrode 14, which are coupled to the link member 24, are pressed toward the workpiece 50 by an urging force of the spring member 26. Thus, a pressing force is applied to the workpiece 50.

Because the link member 24 is coupled to the pressing rod 22 in an inclined state in the spot welding gun 10, a pressing force applied to the workpiece 50 by one spring member 26, that is, a thrust P₁ generated in the pressing rod 22 in the axial direction is represented by the following expression (1), where F is the urging force of the spring member 26, and θ is the inclination angle of the link member 24 with respect to the pressing rod 22.

$$thrust {P}_{1} = F \times cos θ \qquad ( 1 )$$

In the present embodiment, a thrust P represented by the following expression (2) is generated in the pressing rod 22 by two spring members 26.

$$thrust P = 2 F \times cos θ \qquad ( 2 )$$

In the pressing mechanism 20A of the spot welding gun 10, with an operation such that the pressing rod 22 moves toward the proximal end against the urging force of the spring member 26, the spring member 26 becomes compressed as the inclination angle θ of the spring member 26 with respect to the axial direction of the pressing rod 22 increases. For example, as the pressing rod 22 moves toward the proximal end, the spring member 26 becomes compressed and the spring length decreases until reaching the top dead center of compression. At this time, a force that is the product of the spring constant and the compression amount (reduced length) of the spring member 26 acts on the axis of the spring member 26. Thus, as the inclination angle θ increases and the spring member 26 becomes compressed further, the urging force F, which is the elastic restoring force of the spring member 26, increases. On the other hand, the proportion of a force that acts in the axial direction of the pressing rod 22, which is converted from the urging force F, decreases because the value of the trigonometric function cos θ decreases as the inclination angle θ of the spring member 26 increases. According to theoretically calculated values, the proportion changes to 100% when the inclination angle θ is 0 degrees, 86.6% when the inclination angle θ is 30 degrees, 70.7% when the inclination angle θ is 45 degrees, 50% when the inclination angle θ is 60 degrees, and 0% when the inclination angle θ is 90 degrees. In this way, the pressing mechanism 20A according to the present embodiment is structured so that, by increasing/decreasing the inclination angle θ, a substantially constant force is output to the pressing rod 22 by balancing between increase/decrease of the urging force F of the spring member 26 and the proportion of the component force of the urging force F due to the trigonometric function.

When the distal end portion of the electrode 14 of the spot welding gun 10 wears due to multiple spot welding or when plating on a workpiece surface adheres to the surface of the electrode 14 during welding, welding quality declines. Therefore, the surface of the distal end portion of the electrode 14 is periodically polished to maintain the surface condition of the electrode 14.

As the electrode 14 is polished and the dimension of the electrode 14 decreases, when the spot welding gun 10 is disposed by the industrial robot 2 at a predetermined welding position, a distance over which the pressing rod 22 moves toward the proximal end, that is, the stroke length d decreases. When the stroke length d decreases, the compression amount of the spring member 26 decreases and the urging force F decreases. At the same time, the inclination angle θ of the link member 24 during welding, when an electric current is caused to flow between the electrodes 14 and 16, decrease. In other words, the value of cos θ in expressions (1) and (2) becomes larger than that before the electrode 14 is polished. Thus, with the spot welding gun 10 according to the present embodiment, it is possible to maintain a pressing force that acts on the workpiece 50 substantially constant before and after the electrode 14 is polished.

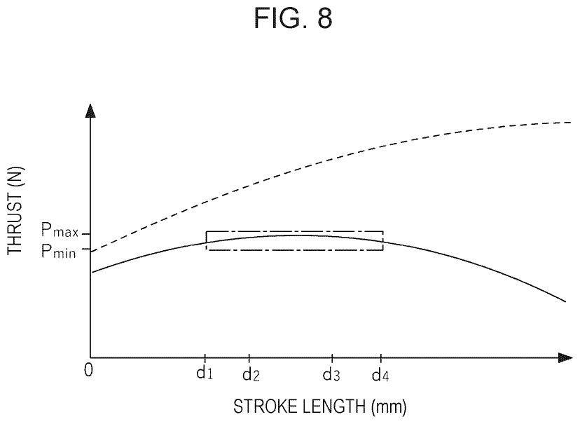

FIG. 8 is a graph illustrating the relationship between the stroke length d of the pressing mechanism 20A and the thrust P generated in the pressing rod 22 by two spring members 26. In FIG. 8, the broken line represents the total value of the urging forces of the two spring members 26. In spot welding, an allowable range is set so that a pressing force that acts on the workpiece 50 remains substantially constant during welding, and a thrust Pₘᵢₙ represents the minimum value in the allowable range and a thrust Pₘₐₓ represents the maximum value in the allowable range. In an initial state in which a new electrode 14 is attached to the spot welding gun 10, the stroke length d during welding is set to a stroke length d₃. A stroke length d₄ is the sum of the stroke length d₃, which is the reference value, and a margin, and is set assuming a case where the pressing rod 22 is pushed further than the reference value. For example, in the present embodiment, the stroke length d₃ is set to 30 mm, and the stroke length d₄ is set to 35 mm.

When the electrode 14 is polished, the stroke length d during welding becomes smaller than the reference value. In general, the electrode 14 is polished multiple times and thus is used until the length of the electrode 14 becomes smaller than the initial dimension by about 10 mm. A stroke length d₂ is a value assuming a case where the dimension of the electrode 14 becomes the minimum, and a stroke length d₁ is a margin assuming a case where the electrode 14 is excessively polished. For example, in the present embodiment, the stroke length d₂ is set to 20 mm, and the stroke length d₁ is set to 15 mm. As represented by the chain-line box in FIG. 8, in the spot welding gun 10, the pressing mechanism 20A is set so that, in the range from the stroke length d₁ to the stroke length d₄, the thrust P falls within the range from the thrust Pₘᵢₙ to the thrust Pₘₐₓ, which is an allowable range. As with the first pressing mechanism 20A, the second pressing mechanism 20B provided on the second electrode 16 is set so that the thrust P falls within an allowable range when the stroke length d during welding changes.

For example, regarding the pressing mechanisms 20A and 20B according to the present embodiment, the allowable range of the thrust P is the range of ±5% with respect to a target value, and it is set so that the inclination angle θ of the spring member 26 becomes less than or equal to 60°, preferably, 40°<θ<60°. Moreover, in the present embodiment, for example, it is set so that the maximum value of the thrust P, which is represented by the solid line in FIG. 8, is included in the allowable range of the thrust P, which is surrounded by the chain line. The second pressing mechanism 20B is set in the same way as the first pressing mechanism 20A. It is possible to change, as appropriate, these numerical ranges in accordance with a target pressing force and members that constitute the pressing mechanism 20A.

As described above, the spot welding gun 10 can cause the thrust P to fall within in an allowable range when the first and second electrodes 14 and 16 are polished, the dimension of each of the electrodes 14 and 16 decreases, and accordingly the stroke length d during welding decreases. Thus, the pressing mechanisms 20A and 20B can maintain a pressing force applied to the workpiece 50 substantially constant before and after the electrodes 14 and 16 are polished. Moreover, because the pressing mechanisms 20A and 20B each have a structure that applies a pressing force to the workpiece 50 by using the spring member 26 and do not need air to apply the pressing force, it is possible to reduce energy consumption when spot welding is performed.

Moreover, with the spot welding gun 10 according to the present embodiment, because the pair of link members 24 and the pair of spring members 26 are disposed line-symmetric with respect to the axial direction of the pressing rod 22 in each of the pressing mechanisms 20A and 20B, forces in directions perpendicular to the axial direction cancel out each other in the pair of spring members 26. Thus, because the pressing mechanisms 20A and 20B can stably cause a thrust in the axial direction to act on the pressing rod 22, it is possible to improve welding quality by stabilizing a pressing force in the vertical direction that acts on the surface of the workpiece 50.

The disclosure is not limited to the embodiment described above, and can be modified in various ways without departing from the gist of the disclosure.

For example, the spot welding gun 10 may be a welding gun that performs series spot welding for welding a workpiece at a contact portion of each of the first electrode 14 and the second electrode 16. Also in series spot welding, the spot welding gun 10 according to the disclosure can perform welding by causing an electric current to flow between the electrodes 14 and 16 while applying a substantially constant pressing force to a workpiece at the contact portion of each of the electrodes 14 and 16.

The spot welding gun 10 may be a welding gun having a structure in which the second electrode 16 is disposed so as to face the first electrode 14 and that causes an electric current to flow between the electrodes 14 and 16 in a state in which a workpiece is held between the first and second electrodes 14 and 16, that is, a welding gun that performs direct spot welding. When the spot welding gun 10 is a welding gun for direct spot welding, one of the first electrode 14 and the second electrode 16 may be a fixed electrode that is fixed to the gun body 12 and the other electrode may be a movable electrode that moves closer to and away from the fixed electrode. The pressing mechanism may be provided only on the movable electrode of the spot welding gun 10.

With a spot welding gun according to the disclosure, it is possible to apply a substantially constant pressing force to a workpiece by pressing an electrode during welding, and it is possible to reduce energy consumption.

1. A spot welding gun comprising:
an electrode configured to contact a workpiece to be welded; and
a pressing mechanism configured to apply a pressing force to the workpiece by pressing the electrode,
wherein the pressing mechanism comprises
a pressing rod that has a distal end to which the electrode is coupled and is configured to reciprocate in an axial direction of the pressing rod, and
at least one link member that includes a distal end portion and a proximal end portion, the distal end portion being coupled to a proximal end side of the pressing rod via a joint member and extends in a direction inclined with respect to the pressing rod so that the proximal end portion becomes more distant from the electrode, and
a spring member configured to urge the link member toward the distal end portion, and
wherein an inclination angle of the link member with respect to the pressing rod decreases as the pressing rod moves toward the electrode.

2. The spot welding gun according to claim 1, wherein the link member comprises a pair of link members and the spring member comprises a pair of spring members, and the pair of link members and the pair of spring members are disposed so as to be line-symmetric with respect to the axial direction of the pressing rod.

3. The spot welding gun according to claim 1,
wherein the pressing mechanism comprises a support member configured to support the proximal end portion of the link member, and
wherein the support member is rotatably attached via a shaft member to a holding member that holds the pressing rod, and is configured to support the proximal end portion of the link member so that the proximal end portion is slidable in an axial direction of the link member.

4. The spot welding gun according to claim 2,
wherein the pressing mechanism comprises a support member configured to support the proximal end portion of the link member, and
wherein the support member is rotatably attached via a shaft member to a holding member that holds the pressing rod, and is configured to support the proximal end portion of the link member so that the proximal end portion is slidable in an axial direction of the link member.

5. The spot welding gun according to claim 1,
wherein the electrode comprises a first electrode and a second electrode between which an electric current is caused to flow via the workpiece,
wherein the pressing mechanism comprises a first pressing mechanism provided on the first electrode and a second pressing mechanism provided on the second electrode, and
wherein the pressing rod of the first pressing mechanism and the pressing rod of the second pressing mechanism are disposed parallel to each other.

6. The spot welding gun according to claim 2,
wherein the electrode comprises a first electrode and a second electrode between which an electric current is caused to flow via the workpiece,
wherein the pressing mechanism comprises a first pressing mechanism provided on the first electrode and a second pressing mechanism provided on the second electrode, and
wherein the pressing rod of the first pressing mechanism and the pressing rod of the second pressing mechanism are disposed parallel to each other.
